(19) United States
(12) Patent Application Publication
(10) Pub. No.: US 2003/0118280 A1
(43) Pub. Date: Jun. 26, 2003

(54) Optical Transmission system

(76) Inventors: Tetsuya Miyazaki, Kamifukuoka-shi (JP); Ryu Watanabe, Kamifukuoka-shi (JP); Hideaki Tanaka, Kamifukuoka-shi (JP); Masatoshi Suzuki, Kamifukuoka-shi (JP); Yukio Horiuchi, Kamifukuoka-shi (JP)

Correspondence Address: CHRISTIE, PARKER & HALE, LLP, 350 WEST COLORADO BOULEVARD, SUITE 500, PASADENA, CA, 91105, US

(21) Appl. No.: 10/308,457

(22) Filed: Dec. 2, 2002

(30) Foreign Application Priority Data
Nov. 30, 2001 (JP) 2001-365788

(51) Int. Cl. G02B 6/28; G02B 6/26; G02F 1/025

(52) U.S. Cl. 385/24; 385/15; 385/1

(57) ABSTRACT

An optical transmission system comprises a light source to output an optical carrier having a predetermined wavelength, a photoelectric converter, an optical transmission line, an optical circulator to apply an output light from the light source to one end of the optical transmission line and to apply a light through the same end of the optical transmission line to the photoelectric converter, and an optical modulator disposed on the other end of the optical transmission line to return a portion of the light from the optical transmission line as a reference light to the optical transmission line without modulation and to modulate another portion of the light from the optical transmission line with a transmission signal to return it to the optical transmission line as a modulated light.

### CROSS REFERENCE TO RELATED APPLICATIONS

This application is based upon the benefit of priority from the prior Japanese Patent Application No. 2001-365788, filed on Nov. 30, 2001, the entire contents of which are incorporated herein by reference.

### FIELD OF THE INVENTION

This invention relates to an optical transmission system using an optical fiber as a signal transmission line, and more specifically relates to an optical transmission system to connect a control station and a radio base station in a wireless communication system.

### BACKGROUND OF THE INVENTION

An optical transmission system to connect a control station (CS) and a radio base station (BS) in a radio communication system is described in T. Kagawa, Y. Doi, T. Ohno, T. Yoshimatsu, K. Tsuzuki and S. Mitachi, “B-directional optical microwave transmission using a base station without DC electric power supply”, Optical Fiber Communication Conference, OFC '01, WV2, 2001.

In this optical transmission system, an optical signal in a signal form identical to that of a radio signal propagates on an optical fiber connecting a CS and a BS. Furthermore, in the BS, an antenna is driven by a result of photoelectric conversion of a received optical signal from the CS through the optical fiber and intensity of the optical signal from the CS is modulated by the received signal of the antenna to return to the CS through another optical fiber. By using the above configuration, electric supply to the BS is no longer necessary.

FIG. 7 shows a schematic block diagram of a conventional system. A control station 110 connects to a base station 140 through optical fibers 130 and 132. The base station 140 communicates with a mobile terminal 160 by wireless using its antenna 142.

In the control station 110, a transmitter-receiver 112 outputs a down stream signal Sd. A DFB laser 114 outputs a CW (continuous wave) laser light of a predetermined wavelength. An optical intensity modulator 116 comprising an electroabsorption optical modulator analog-modulates intensity of the output light from the DFB laser 114 with the down stream signal Sd. Generally, the degree of modulation is approximately 10%. An optical amplifier 118 amplifies the output light from the optical intensity modulator 116 and outputs onto an optical fiber 130.

The light propagated on the optical fiber 130 enters the base station 140 to be divided into two portions by an optical coupler 144. One portion of the light divided by the optical coupler 144 enters a uni-traveling carrier-photodiode (UTC-PD) 146, and the other enters an optical intensity modulator 150 comprising an electroabsorption optical modulator. The UTC-PD 146 comprises a photodetector capable of processing strong light and performing zero bias operation. The UTC-PD 146 converts an input light into an electric signal and applies to a port A of a diplexer 148. The output from the UTC-PD 146 includes the down stream signal Sd itself.

The diplexer 148 applies the output from the UTC-PD 146 to the antenna 142 through its port B. That is, the antenna 142 is driven by the output from the UTC-PD 146 and emits the down stream signal Sd of radio wave to a down stream link existing between the antenna 142 and the mobile terminal 160.

The mobile terminal 160 outputs an up stream signal Su of radio wave for the other terminal to an up stream link existing between the mobile terminal 160 and the base station 140. The antenna 142 receives the up stream signal Su of radio wave and applies to the port B of the diplexer 148. The diplexer 148 applies the output from the antenna 142, namely the up stream signal Su, to the optical intensity modulator 150 through a port C. The optical intensity modulator 150 analog-modulates the intensity of the light from the optical coupler 144 with the up stream signal Su from the diplexer 148. The light whose intensity was modulated by the up stream signal Su at the optical intensity modulator 150 enters the optical fiber 132, propagates on the optical fiber 132, and enters the control station 110.

RF carrier frequencies of the up and down stream links between the base station 140 and the mobile station 160 are different from each other. That is, the RF carrier frequencies of the up stream signal Sd and the down stream signal Su are different from each other. Therefore, even if the intensity of the light modulated by the down stream signal Sd is further modulated by the up stream signal Su, the up stream signal Su can be separated at the control station 110 as to be mentioned below.

The light propagated on the optical fiber 132 enters a photoelectric converter 120 in the control station 110 and is converted into an electric signal. The output from the photoelectric converter 120 includes the up stream signal Su itself. The output from the photoelectric converter 120 is amplified by an amplifier 122 and enters a filter 124 that extracts a frequency component of the up stream signal Su. The filter 124 extracts the frequency component of the up stream signal Su from the output from the amplifier 122 and applies the extracted up stream signal Su to the transmitter-receiver 112.

The, antenna 142, the optical coupler 144, the UTC-PD 146, and the diplexer 148 are capable of operating without electric power supply. By operating the electroabsorption modulator of the optical intensity modulator 150 with no bias, the optical intensity modulator 150 is also capable of operating without power feeding. Thus, the whole base station 140 can operate without electric power supply.

However, in the conventional art shown in FIG. 7, receiving sensitivity is low because the control station 110 directly detects the intensity of the light whose intensity was analog-modulated according to the up stream signal Su at the base station 140 for a transmission method of the up stream signal Su. Therefore, it is impossible to extend the distance between the control station 110 and the base station 140.

To improve the receiving sensitivity, an optical amplifier should be disposed on either of the input side or the output side of the optical intensity modulator 150. However, in that case, it is required to feed the optical amplifier and so the base station is no longer capable of operating without electric power supply. It is also applicable to dispose the optical amplifier on the input side of the photoelectric converter 120 of the control station 110. However, since a modulation rate of the output light from the optical intensity modulator 150 is as low as a few percent, it is difficult to improve a C/N even if it is optically amplified immediately before the photoelectric converter 120.

In the configuration shown in FIG. 7, the light output from the control station 110 is also used to carry the up stream signal Su from the base station 140 to the control station 110. Accordingly, it is required to have an optical amplifier 118 to amplify the light before being output for the optical fiber 130 from the control station 110. However, since an EDFA (erbium doped fiber amplifier) generally used for the optical amplifier 118 is very expensive, the cost to make the system goes up enormous in such case that a large number of the base stations 140 is connected to the control station 110.

A demand for transmitting signals from a distant area with no power supply or low power consumption exists at a variety of fields. For instance, at a fringe area where reception of ground wave television broadcasting is poor, there is a demand to set an antenna on a mountaintop where reception of the broadcasting wave is possible and to transmit received waves for the fringe area. In this case, it is also preferable that a receiver to be connected with the antenna operates without electric power supply.

### SUMMARY OF THE INVENTION

An optical transmission system according to the present invention comprises a light source to output an optical carrier of a predetermined wavelength, a photoelectric converter, an optical transmission line, an optical circulator to apply an output light from the light source to one end of the optical transmission line and to apply an output light from the same end of the optical transmission line to the photoelectric converter, and an optical modulator disposed on the other end of the optical transmission line to return one portion of the light from the optical transmission line without modulation as a reference light and to modulate another portion of the light from the optical transmission line with a transmission signal to return it to the optical transmission line as a modulated light.

According to the above configuration, a signal can be sent to a distant area with no electric power supply or low power consumption. The signal is detected with high sensitivity using homodyne detection. The signal can be transmitted in such condition that influences of polarization and optical phase variation on an optical transmission line are canceled each other out.

Preferably, the optical transmission line comprises an optical fiber.

Preferably, the optical modulator comprises an optical intensity modulator to analog-modulate intensity of another portion of the light from the optical transmission line with the transmission signal or an optical phase modulator to analog-modulate optical phase of the portion.

Preferably, the optical modulator has no bias.

Preferably, one surface of the optical modulator facing to the optical transmission line comprises partially reflective facet, and the other surface comprises highly reflective, or preferably totally reflective facet in substance. According to this configuration, the optical modulator outputs a modulated light of multiple-reflection. Owing to the multiple-reflection, modulation efficiency is improved.

Preferably, the optical transmission system according to the present invention further comprises a wavelength controller to control the wavelength of the light source according to the output from the photoelectric converter. By using this configuration, the operating point of the optical modulator is controlled to keep a desirable position even if modulation characteristics of the optical modulator vary due to variation of ambient temperature of the optical modulator.

Also, the optical transmission system according to the present invention comprises a control station having a light source to generate an optical carrier, a base station to communicate with a mobile terminal by wireless, and an optical transmission line to transmit a first signal light modulated with a down stream signal from the control station to the base station, to transmit the optical carrier from the control station to the base station, and to transmit a second signal light including the optical carrier modulated with the up stream signal from the base station to the control station. The optical transmission system is characterized in that the base station comprises an optical modulator to modulate a portion of the optical carrier with the up stream signal, and the second signal light comprises a non-modulated reflect light of the optical carrier as a reference light and a modulated light by the optical modulator.

The above configuration makes it possible for a wireless communication system to achieve higher receiving sensitivity while an up stream signal is transmitted in analog mode. Also, the base station can be substantially operated without electric power supply. Therefore, it is possible to provide a low-cost optical transmission system to connect a control station and a radio base station in a wireless communication system. An up stream signal can be detected at high sensitivity using homodyne detection. A signal can be transmitted in such condition that influences of polarization and optical phase variation on an optical transmission line are cancelled each other out.

Preferably, the control station comprises a first optical coupler to couple the first signal light and the optical carrier to supply to the optical transmission line and to separate the second signal light from the light from the optical transmission line, and the base station comprises a second optical coupler to separate the first signal light and the optical carrier input from the optical transmission line and to supply the second signal light to the optical transmission line. According to the above configuration, an optical transmission line can be realized using only one optical fiber, and thus system costs can be decreased.

Preferably, the control station further comprises a signal light source to generate the first signal light to supply to the first optical coupler, a detector to detect the second signal light to output an electric signal, and an optical circulator to supply the output light from the light source to the first optical coupler and to supply the second signal light output from the first optical coupler to the detector.

Preferably, the base station comprises an antenna for wireless communication, a photoelectric converter to convert the first signal light from the second optical coupler into an electric signal, and a circulator to supply the output from the photoelectric converter to the antenna and to supply the output from the antenna to the optical modulator.

Preferably, the optical transmission line comprises a first optical line to transmit the first signal light from the control station to the base station, and a second optical line to transmit the optical carrier from the control station to the base station and to transmit the second signal light from the base station to the control station. With the above configuration, limitation for the wavelengths of the first and second signal lights is cancelled and the WDM multiplexing/demultiplexing at the control station and the base station becomes no longer necessary.

Preferably, the control station further comprises a signal light source to generate the first signal light to supply to the first optical line through one end of the first optical line, a detector to detect the second signal light to output an electric signal, and an optical circulator to supply the output light from the light source to the second optical line through one end of the second optical line and to supply the second signal light from the same end of the second optical line to the detector.

Preferably, the base station comprises an antenna for wireless communication, a photoelectric converter to convert the first signal light input from the first optical line into an electric signal, and a circulator to supply the output from the photoelectric converter to the antenna and to supply the output from the antenna to the optical modulator.

Preferably, each of the first and second optical lines comprises an optical fiber.

Preferably, the optical modulator comprises an optical intensity modulator to analog-modulate optical intensity of a portion of the optical carrier with the up stream signal or comprises an optical phase modulator to analog-modulate optical phase of a portion of the optical carrier with the up stream signal.

Preferably, the optical modulator has no bias.

Preferably, one end surface of the optical modulator facing to the second optical transmission line comprises partially reflective facet, and the other surface comprises highly reflective, or preferably totally reflective facet in substance. With the above configuration, the optical modulator outputs a modulated light of multiple reflection. Owing to the multiple reflection, modulation efficiency is improved.

Preferably, the optical transmission system according to the present invention further comprises a wavelength controller to control the wavelength of the light source according to the output from the detector. With this configuration, an operating point of an optical modulator is controlled to keep a desirable position even if modulation characteristics vary due to ambient temperature variation of the optical modulation.

### BRIEF DESCRIPTION OF THE DRAWING

The above and other objects, features and advantages of the present invention will be apparent from the following detailed description of the preferred embodiments of the invention in conjunction with the accompanying drawings, in which:

FIG. 1 is a schematic block diagram of a first embodiment of the present invention;

FIG. 2 shows an optical propagating path in and out of the optical modulator 48 and an end surface configuration of an optical fiber 32;

FIG. 3 is a schematic block diagram of a second embodiment of the present invention;

FIG. 4 illustrates modulation characteristics of an optical phase modulator considering internal multiple reflection;

FIG. 5 illustrates modulation characteristics of an optical intensity modulator of a Mach-Zehnder type considering multiplex reflection;

FIG. 6 illustrates modulation characteristics of an optical intensity modulator of an electroabsorption optical modulator considering multiple reflection; and

FIG. 7 shows a schematic block diagram of a conventional system.

### DETAILED DESCRIPTION

Embodiments of the invention are explained below in detail with reference to the drawings.

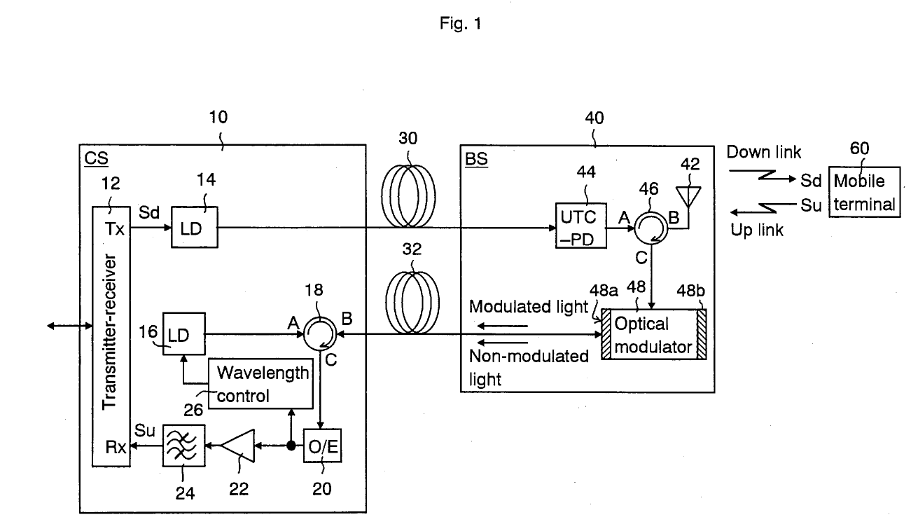

FIG. 1 shows a schematic block diagram of a first embodiment of the present invention. A control station 10 connects to a base station 40 through optical fibers 30 and 32. The base station 40 communicates with a mobile terminal 60 by wireless through its antenna 42.

In the control station 10, a transmitter-receiver 12 outputs a down stream signal Sd. A laser 14 outputs a laser light of wavelength λd whose optical intensity was analog-modulated with the down stream signal Sd. The degree of modulation is generally approximately 10%. A laser 16 outputs a CW laser light of wavelength λu. This CW laser light becomes an optical carrier to carry a radio signal from the base station 40 to the control station 10 as to be mentioned below. The optical carrier can be an optical pulse having a clock frequency twice or more higher than that of the radio signal. The wavelengths λd and λu of the lasers 14 and 16 can be either identical or different. The laser 16 comprises a laser element that is capable of controlling its oscillation frequency. The output from the laser 14 propagates on an optical fiber 30 and enters the base station 40. The output light from the laser 16 enters an optical fiber 32 through an optical circulator 18, propagates on the optical fiber 32, and enters the base station 40.

In this embodiment, the output light from the laser 16 is used to transmit an up stream signal Su from the base station 40 to the control station 10. The output light from the laser 14 is used only to transmit the down stream signal Sd from the control station 10 to the base station 40. Since loss factors are very little, optical amplifiers to optically amplify the output lights from the lasers 14 and 16 are unnecessary in the control station 10.

In the base station 40, the light from the optical fiber 30 enters an UTC-PD 44. The UTC-PD 44 converts the input light into an electric signal and sends to a port A of a diplexer 46. The output from the UTC-PD 44 includes the down stream signal Sd itself.

The diplexer 46 supplies the output from the UTC-PD 44 to the antenna 42 through its port B. That is, the antenna 42 is driven by the output from the UTC-Pd 44 and emits a down stream signal Sd of radio wave onto a down stream link existing between the antenna 42 and the mobile terminal 60.

The mobile terminal 60 outputs an up stream signal Su of radio wave for the other terminal toward an up stream link existing between the mobile terminal 60 and the base station 40. The antenna 42 receives the up stream signal Su of radio wave and applies to the port B of the diplexer 46. The diplexer 46 supplies the output from the antenna 42, or the up stream signal Su, to an optical modulator 48 through its port C.

The CW laser light entered the base station 40 from the optical fiber 32 inputs the optical modulator 48. One end surface 48a of the optical modulator 48 facing to the optical fiber 32 is partially reflective against the wavelength λu, and the other end surface 48b is 100% reflective against the wavelength λu. The optical modulator 48 comprises a crystal of LiNbO₃ or an electroabsorption optical modulator. However, it is difficult to form a 100% reflective surface and thus the reflectivity of the end surface 48b may be substantially approximately 100%.

A portion of the light from the optical fiber 32 is reflected by the front surface 48a and returns to the optical fiber 32, and the rest of the light passed through the front surface 48a is totally reflected by the back surface 48b. Then, a portion of the reflected light passes through the front surface 48a again to reenters the optical fiber 32. While the light is going up-and-down in the optical modulator 48, the intensity of the CW laser of wavelength λu is analog-modulated by the up stream signal Su from the port C of the diplexer 46.

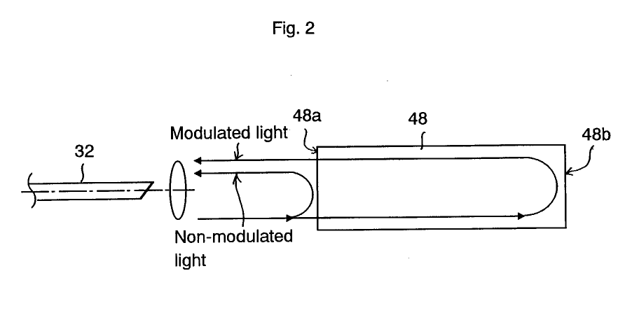

FIG. 2 shows a configuration example of an optical propagation path at the end surfaces 48a and 48b of the optical modulator 48 and in the optical modulator 48, and an example of the end configuration of the optical fiber 32. If any other reflection lights exist other than those reflected by the end surface 48a, the receiving sensitivity of the up stream signal Su at the control station 10 deteriorates, and thus the end surface of the optical fiber 32 is beveled as shown in FIG. 2.

Inside of the optical modulator 48, attenuation becomes greater. However, the multiple reflection between the partial reflecting surface 48a and the 100% reflecting surface 48b is to improve modulation efficiency by appropriately selecting a operation point in the optical modulator 48 as to be described below.

The light (non-modulated light, namely reference light for homodyne detection) reflected by the front surface 48a of the optical modulator 48 and the light (modulated light) totally reflected by the end surface 48b of the optical modulator 48, whose intensity is modulated by the up stream signal Su while it is going up and down in the optical modulator 48, both propagate on the optical fiber 32 toward the control station 10 and enter a port B of an optical circulator 18 in the control station 10. The optical circulator 18 outputs the non-modulated light and the modulated light from the optical fiber 32 for a photoelectric converter 20 through a port C.

The photoelectric converter 20 homodyne-detects the modulated light using the non-modulated light as a local oscillation light and outputs the detection result as an electric signal. Owing to this delayed self-interference detection, the receiving sensitivity is greatly improved. The output from the photoelectric converter 20 includes the up stream signal Su itself. The output from the photoelectric converter 20 is amplified by an amplifier 22 and enters a filter 24 that extracts frequency components of the up stream signal Su. The filter 24 extracts the frequency components of the up stream signal Su from the output of the amplifier 22 and applies the up stream signal Su to a transmitter-receiver 12.

The output from the photoelectric converter 20 is also applies to a wavelength controller 26. The wavelength controller 26 judges whether a center point of the modulating operation in the optical modulator 48 is appropriate by checking the output signal from the photoelectric converter 20 and, if it is off the proper position, controls the wavelength of the laser 16 so as to correct the position.

The antenna 42, the UTC-PD 44, and the diplexer 46 are capable of operating without electric power supply. By operating the optical modulator 48 with no bias, the optical modulator 48 is also capable of non-feeding operation. Therefore, the base station 40 can be completely operated without electric power supply.

To achieve the delayed self-interfering detection in the photoelectric converter 20, it is necessary not to have any other reflecting point of the wavelength λu on the optical fiber 32 but the end surface 48a. In the configuration shown in FIG. 2, although the end surface of the optical fiber 32 is beveled while the front surface 48a of the optical modulator 48 is partially reflective, it is also applicable, conversely, to form the front surface 48a of the optical modulator 48 slantingly against the optical axis and make the end surface of the optical fiber 32 partially reflective. However, the configuration shown in FIG. 2 is easier to product compared to the latter.

Also, a commercial type optical modulator is sold in such style that short optical fibers called pigtail are spliced on both ends. Thus, it is applicable to form a partially reflecting surface and a totally reflecting surface using end surfaces of the pigtails corresponding to the end surfaces 48a and 48b.

A configuration that does not dispose a lens between an optical modulating element and optical fiber is also generally used. For instance, an optical fiber is directly glued to an end surface of the optical modulating element using UV cured resin having refractivity matched to that of the optical fiber.

In this embodiment, the up stream signal is received with high sensitivity owing to the homodyne detection. Therefore, it is unnecessary to dispose an expensive optical amplifier to amplify the output light from the laser 16. Furthermore, the detection sensitivity is very high and so the up stream signal Su can be properly received even if the degree of modulation by the optical modulator 48 in the base station 40 was low. This means that it is possible to extend the distance between the base station 40 and the mobile terminal 60 and/or to reduce the wireless outputs from the mobile terminal 60 (these are generically called loss budget).

When coherent length of the laser 16 is longer than the optical fiber 32, it is unnecessary to overly narrow the spectral line width of the output light from the laser 16. If necessary, the spectral line width can be narrowed using a fiber grating etc.

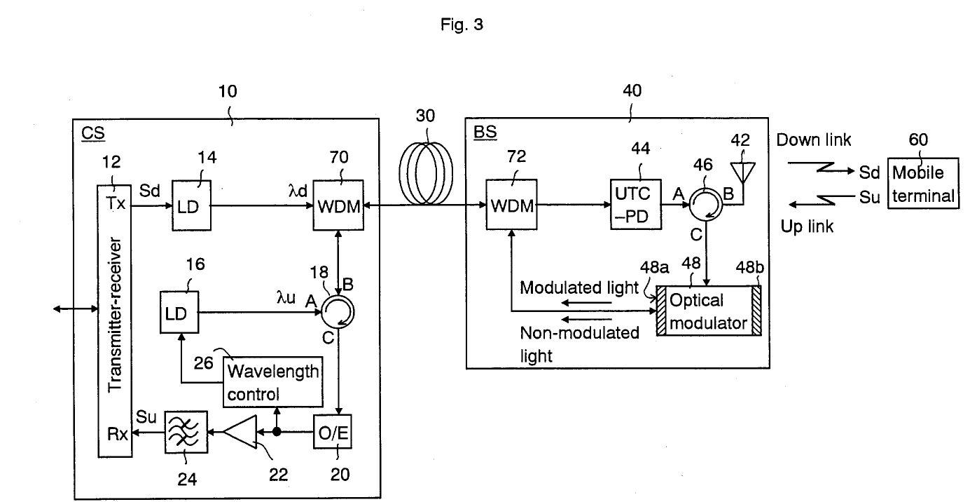

In the embodiment shown in FIG. 1, the two optical fibers 30 and 32 are required between the control station 10 and the base station 40. By utilizing wavelength-division-multiplexing technique, it is possible to reduce the number of the optical fibers from two to one. FIG. 3 shows a schematic block diagram of such a modified embodiment. The elements identical to those in FIG. 1 are labeled with the common reference numerals.

WDM optical couplers 70 and 72 to demultiplex/multiplex an optical carrier (wavelength λd) carrying a down stream signal Sd and an optical carrier (wavelength λu) carrying an up stream signal Su are disposed on both ends of an optical fiber 30. That is, the WDM optical coupler 70 connects a laser 14 and one end of the optical fiber 30 in relation to the light of wavelength λd and connects a port B of an optical circulator 18 and the one end of the optical fiber 30 in relation to the light of wavelength λu. The WDM optical coupler 72 connects the other end of the optical fiber 30 and an UTC-PD 44 in relation to the light of wavelength λd and connects the other end of the optical fiber 30 and an optical modulator 48 in relation to the light of wavelength λu.

In the embodiment shown in FIG. 3, it is obvious that the wavelengths λd and λu are different from each other. Since the process itself for the down stream signal Sd and the upstream signal Su is identical to that shown in FIG. 1, its detail explanation is omitted.

Although the optical intensity modulation is used to transmit the up stream signal from the base station 40 to the control station 10 in the embodiments shown in FIGS. 1 and 3, optical phase modulation is also applicable. When the optical phase modulation is used, a so-called optical phase modulator is used as the optical modulator 48.

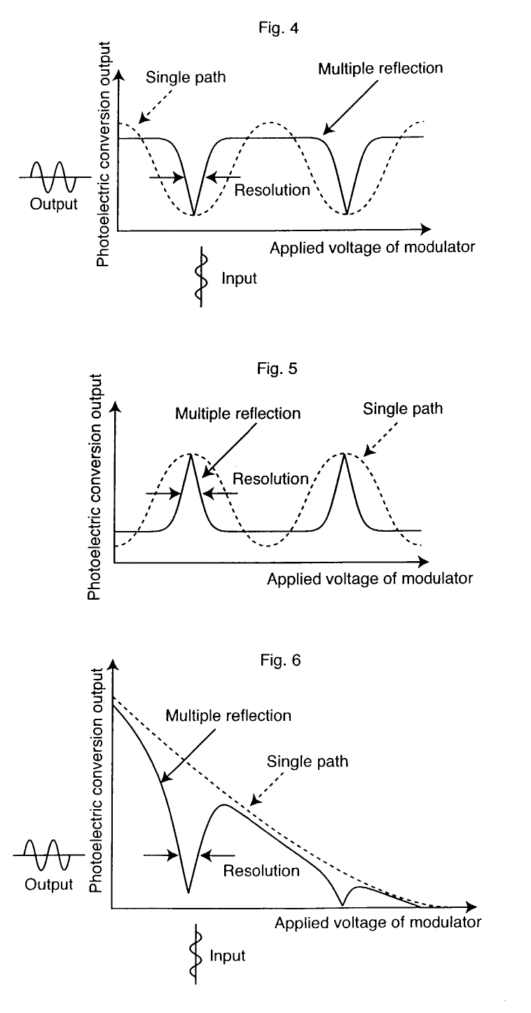

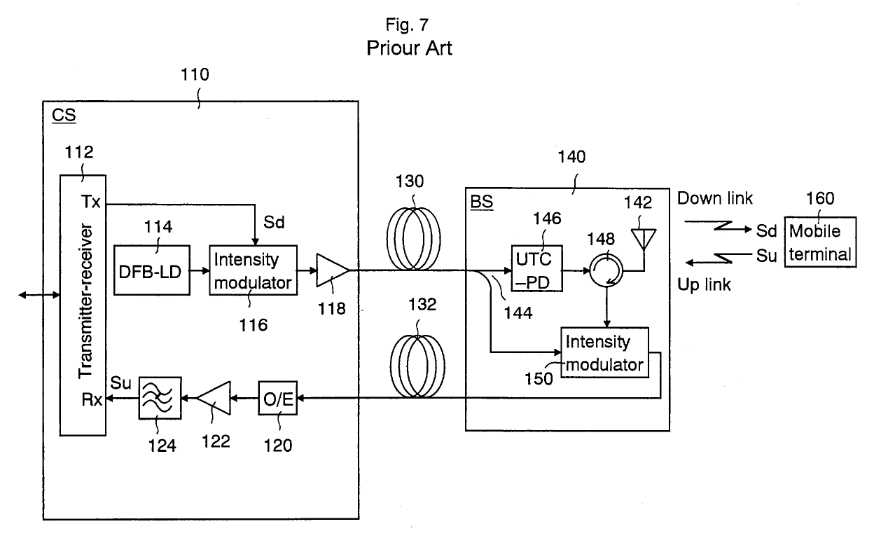

The effect of the multiple reflection inside the optical modulator 48 is to be explained below. To make it easily understandable, a configuration in which the optical phase modulation is used is explained first. FIG. 4 shows modulation characteristics of an optical phase modulator. The horizontal axis expresses the applied voltage of modulator and the vertical axis expresses output of a photoelectric converter. The solid line shows characteristics when light is multi-reflected in an optical phase modulator, and the broken line shows ordinary characteristics when light propagates in the optical phase modulator one time only.

In the ordinary use (the broken line), the photoelectric converting output changes in a sine wave against the applied voltage of modulator. On the other hand, in the multi-reflection case, at the applied voltage of modulator corresponding to a roundtrip cycle, the characteristics become steeper than those of the sine wave because of a resonator formed by the both end surfaces. When a center voltage of input transmission signal (the applied voltage of modulator) is set on the steep characteristic part, variation of output becomes greater than that of a single path. That is, the modulation efficiency is improved.

The modulation characteristics shown in FIG. 4 vary according to ambient temperature etc. As shown in FIG. 4, when a part of the optical modulator whose input/output characteristics vary steeply is used, a driving point of the optical modulator is tend to slide off a desirable position. Therefore, in the present embodiments, a wavelength controller 26 is disposed in the controller 10 to feedback-control an oscillation wavelength of the laser 16 so that the driving position returns to the optimum position according to the shifting of the driving position by the variation of the characteristics of the optical modulator 48.

FIG. 5 shows the modulation characteristics of an optical intensity modulator wherein an optical phase modulator is configured in a Mach-Zehnder structure. FIG. 6 shows modulation characteristics of an optical intensity modulator using an electroabsorption optical modulator. In both Figures, the horizontal axis expresses applied voltage of modulator, and the vertical axis expresses output of photoelectric converter. The solid line shows characteristics when light is multi-reflected in an optical intensity modulator, and the broken line shows normal characteristics when the light propagates in the optical intensity modulator once.

An electroabsorption optical modulator (FIG. 6) uses such characteristics wherein its loss differs according to applied voltage of modulator and thus, when the multi-reflection is performed, monotonic loss characteristics of a single path overlaps with periodicity due to the resonant configuration. Even in this case, if a center voltage of an input transmission signal (applied voltage of modulator) is set to a part showing steep variation characteristics, the variation of output becomes greater than that of a single path. That is, the modulation efficiency is improved.

The wavelength controller 26 can be also a circuit simply to monitor an average output level of the photoelectric converter 20 and to finely adjust the wavelength of the laser 16 so as to keep the level within a predetermined range. It is also applicable to slightly modulate the output light from the laser 16 with a tone signal having a frequency other than the frequency band of a signal carried from the base station 40 to the control station 10, to extract the tone frequency component from the output from the photoelectric converter 20, and to control the wavelength of the laser 16 so that amplitude of the tone frequency component keeps a predetermined value. Such a wavelength control itself is already known.

As readily understandable from the aforementioned explanation, by applying the present invention for signal transmission between a control station and a base station in a wireless transmission system, receiving sensitivity of an up stream signal is improved keeping the base station without electric power supply. This makes it possible to extend the distance between a control station and a base station. It is not necessary to dispose an optical amplifier in the control station. Owing to the above configuration, costs of a wireless communication system can be greatly reduced. By using an optical modulator to multi-reflect an optical carrier inside the optical modulator, modulation efficiency is improved.

Also, according to the present invention, it is possible to transmit a signal in a distant area through a base station disposed at the area for a control station with a simple configuration. Since the base station is capable of operating with no electric power supply, it is possible to transmit a signal from an area where an electric power supply condition is very poor or an area where electric power consumption is undesirable to a distant control station.

While the invention has been described with reference to the specific embodiment, it will be apparent to those skilled in the art that various changes and modifications can be made to the specific embodiment without departing from the spirit and scope of the invention as defined in the claims.

1. An optical transmission system comprising:
a light source to output an optical carrier having a predetermined wavelength;
a photoelectric converter;
an optical transmission line;
an optical circulator to apply an output light from the light source to one end of the optical transmission line and to apply a light through the same end of the optical transmission line to the photoelectric converter; and
an optical modulator disposed on the other end of the optical transmission line to return a portion of the light from the optical transmission line as a reference light to the optical transmission line without modulation and to modulate another portion of the light from the optical transmission line with a transmission signal to return it to the optical transmission line as a modulated light.

2. The optical transmission system of claim 1 wherein the optical transmission line comprises an optical fiber.

3. The optical transmission system of claim 1 wherein the optical modulator comprises an optical intensity modulator to analog-modulate intensity of another portion of the light from the optical transmission line by the transmission signal.

4. The optical transmission system of claim 1 wherein the optical modulator comprises an optical phase modulator to analog-modulate optical phase of another portion of the light from the optical transmission line by the transmission signal.

5. The optical transmission system of claim 1 wherein the optical modulator has no bias.

6. The optical transmission system of claim 1 wherein one end surface of the optical modulator facing to the optical transmission line comprises partially reflective facet and the other surface substantially comprises totally reflective facet.

7. The optical transmission system of claim 1 further comprising a wavelength controller to control a wavelength of the light source according to an output from the photoelectric converter.

8. An optical transmission system comprising:
a control station having a light source to generate an optical carrier;
a base station to communicate with a mobile terminal by wireless; and
an optical transmission line to transmit a first signal light modulated with a down stream signal from the control station to the base station, to transmit the optical carrier from the control station to the base station, and to transmit a second signal light including the optical carrier modulated by the up stream signal from the base station to the control station,
the optical transmission system characterized in that;
the base station comprises an optical modulator to modulate a portion of the optical carrier with the up stream signal, and the second signal light comprises a non-modulated reflect light of the optical carrier as a reference light and a modulated light modulated by the optical modulator.

9. The optical transmission system of claim 8 wherein the control station comprises a first optical coupler to couple the first signal light and the optical carrier to supply to the optical transmission line and to separate the second signal light from the light from the optical transmission line, and the base station comprises a second coupler to separate the first signal light and the optical carrier input from the optical transmission line and to supply the second signal light to the optical transmission line.

10. The optical transmission system of claim 9 wherein the control station further comprises:
a signal light source to generate the first signal light and to supply the first signal light to the first optical coupler;
a detector to detect the second signal light and to output an electric signal; and
an optical circulator to supply an output light from the light source to the first optical coupler and to supply the second signal light from the first optical coupler to the detector.

11. The optical transmission system of claim 9 or 10 wherein the base station comprises:
an antenna for wireless communication;
a photoelectric converter to convert the first signal light from the second optical coupler into an electric signal; and
a circulator to supply an output from the photoelectric converter to the antenna and to supply an output from the antenna to the optical modulator.

12. The optical transmission system of claim 8 wherein the optical transmission line comprises a first optical line to transmit the first signal light from the control station to the base station and a second optical line to transmit the optical carrier from the control station to the base station and to transmit the second signal light from the base station to the control station.

13. The optical transmission system of claim 12 wherein the control station further comprises:
a signal light source to generate the first signal light to supply to the first optical line through one end of the first optical line;
a detector to detect the second signal light and to output an electric signal; and
an optical circulator to supply the output light from the light source to the second optical line through one end of the second optical line and to supply the second signal light output from the same end of the second optical line to the detector.

14. The optical transmission system of claim 12 or 13 wherein the base station comprises:
an antenna for wireless communication;
a photoelectric converter to convert the first signal light from the first optical line into an electric signal; and
a circulator to supply an output from the photoelectric converter to the antenna and to supply an output from the antenna to the optical modulator.

15. The optical transmission system of claim 11 wherein each of the first and second optical lines comprises an optical fiber.

16. The optical transmission system of claim 8 wherein the optical modulator comprises an optical intensity modulator to analog-modulate optical intensity of a portion of the optical carrier with the up stream signal.

17. The optical transmission system of claim 8 wherein the optical modulator comprises an optical phase modulator to analog-modulate optical phase of a portion of the optical carrier with the up stream signal.

18. The optical transmission system of claim 8 wherein the optical modulator has no bias.

19. The optical transmission system of claim 8 wherein one end surface of the optical modulator facing to the second optical transmission line comprises partially reflective facet and the other surface substantially comprises totally reflective facet.

20. The optical transmission system of claim 10 or 13 further comprising a wavelength controller to control a wavelength of the light source according to an output from the detector.
